(19) United States
(12) Patent Application Publication
(10) Pub. No.: US 2025/0329009 A1
(43) Pub. Date: Oct. 23, 2025

(54) SOLDER INSPECTION DEVICE USING NEURAL NETWORK AND OPERATION METHOD THEREOF

(71) Applicants: SK hynix Inc., Icheon-si (KR); POSTECH RESEARCH AND BUSINESS DEVELOPMENT FOUNDATION, Pohang-si (KR)

(72) Inventors: Seunghun BAEK, Pohang-si (KR); Jaeyoon SIM, Seoul (KR); Won Hwa KIM, Pohang-si (KR); Siyeon PARK, Icheon-si (KR); Cheolung YANG, Icheon-si (KR); Songyi JEON, Icheon-si (KR)

(21) Appl. No.: 19/072,612

(22) Filed: Mar. 6, 2025

(30) Foreign Application Priority Data
Apr. 23, 2024 (KR) 10-2024-0054209

(51) Int. Cl. G06T 7/00; G06V 10/764; G06V 10/82

(52) U.S. Cl. CPC G06T 7/0008; G06V 10/764; G06V 10/82; G06T 2207/30141; G06T 2207/30152

(57) ABSTRACT

A solder inspection device includes a position search circuit configured to receive a substrate image of a substrate including a plurality of solder area and to generate a plurality of search images corresponding to the plurality of solder areas; an inspection image generating circuit configured to generate a plurality of inspection images corresponding to the plurality of solder areas by using a plurality of reference masks and position information of the plurality of search images; and a classification circuit configured to classify each of the plurality of inspection images as having one of a plurality of states.

### CROSS-REFERENCE TO RELATED APPLICATIONS

The present application claims priority to Korean Patent Application No. 10-2024-0054209, filed on Apr. 23, 2024, which is incorporated herein by reference in its entirety.

### BACKGROUND

### 1. Technical Field

Embodiments relate to a solder inspection device using a neural network and an operation method thereof.

### 2. Related Art

In the conventional art, in order to inspect for soldering defects, the board was directly inspected using a microscope and types of defects were classified manually.

Manual classification work requires excessive work time and has the problem of deviations in inspection quality depending on the products being inspected or inspectors.

### SUMMARY

In accordance with an embodiment of the present disclosure, a solder inspection device may include a position search circuit configured to receive a substrate image of a substrate including a plurality of solder areas and to generate a plurality of search images respectively corresponding to the plurality of solder areas; an inspection image generating circuit configured to generate a plurality of inspection images respectively corresponding to the plurality of solder areas using a plurality of reference masks and position information of the plurality of search images; and a classification circuit configured to classify each of the plurality of inspection images as having one of a plurality of states.

In accordance with an embodiment of the present disclosure, a method of operating a solder inspection device may include receiving, by a classification neural network of the solder inspection device, a plurality of inspection images of solder areas of a substrate; assigning one of a first state and a second state to the inspection image; determining, in a first epoch learning of the classification neural network, a number of first cases for which a sample of the first inspection image having the first state is classified as having the first state, and a number of second cases for which the sample of the first inspection image having the first state is classified as having the second state; and adjusting a first selection probability that a sample of the first state is selected and a second selection probability that a sample of the second state is selected during the next epoch learning.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments that include various features, and explain various principles and beneficial aspects of those embodiments.

FIG. 1 illustrates circuits of a solder inspection device according to an embodiment of the present disclosure.

FIGS. 2A to 2C illustrate operations of a position search circuit according to an embodiment of the present disclosure.

FIG. 3 illustrates an operation of an inspection image generating circuit according to an embodiment of the present disclosure.

FIGS. 4A to 4D illustrate operations of an inspection image generating circuit and a classification circuit according to an embodiment of the present disclosure.

FIG. 5 illustrates a learning operation of a classification circuit according to an embodiment of the present disclosure.

### DETAILED DESCRIPTION

Various embodiments will be described below with reference to the accompanying figures. Embodiments are provided for illustrative purposes and other embodiments that are not explicitly illustrated or described are possible. Further, modifications can be made to embodiments of the present disclosure that will be described below in detail.

A circuit used in the present disclosure can be implemented by hardware, software, or a combination thereof using deep neural network technology, and the circuit can also be referred to as a neural network circuit. The circuit may perform processes including the processes disclosed herein by executing computer programs stored in one or more memories, a storage device, or combinations thereof. In some embodiments, aspects of processes disclosed herein may be performed by a circuit using specialized logic hardware (not shown) such as an Application-Specific Integrated Circuit (ASIC) or Field Programmable Gate Array (FPGA), either alone or in conjunction with a Central Processing Unit (CPU) and/or Graphics Processing Unit (GPU). The memories may include volatile (e.g. RAM) and nonvolatile (e.g. ROM, Flash) memories. The storage device may include, for example, a hard disk drive (HDD), a solid-state drive (SSD), a removable media such as an optical disc loaded into an appropriate optical disk drive, or the like, or combinations thereof. The storage device and memory are each non-transitory computer readable media that may have computer executable instructions stored thereon which, when executed by the appropriate hardware (such as a CPU or GPU), cause the circuit to perform one or more operations according to embodiments of the present disclosure. In some embodiments, neural network aspects of the circuit may comprise a GPU which may be used to train and/or implement machine learning aspects of a convolutional neural network (CNN) comprised in the circuit. In some embodiments, the circuit may comprise input/output (I/O) devices configured to transmit and receive data, including image information. One or both of a solder inspection device and a circuit of the solder inspection device may further comprise hardware such as an imaging device, e.g. an assembly of lenses and a CMOS image sensor which converts light into digital images, etc. A solder inspection device may comprise additional hardware components as known in the art, such as a loading tray for mounting inspection articles, a case, a display, input devices, etc.

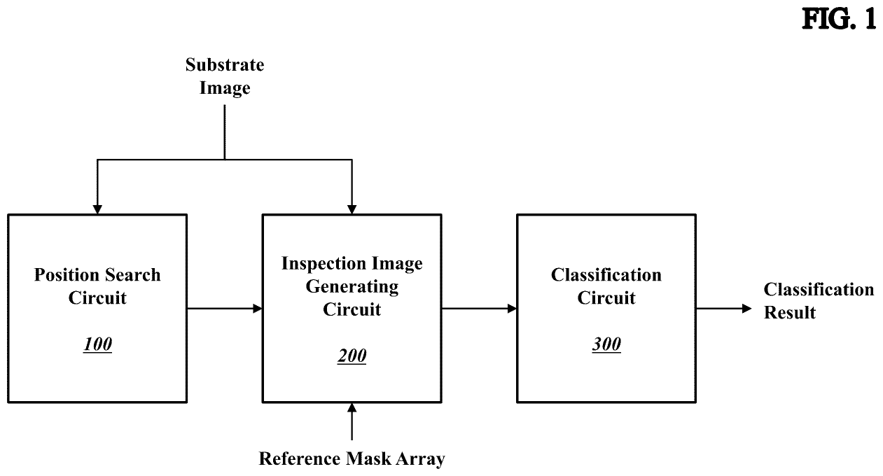

FIG. 1 is a block diagram showing circuits of a solder inspection device 1 according to an embodiment of the present disclosure.

The solder inspection device 1 includes a position search circuit 100, an inspection image generating circuit 200, and a classification circuit 300.

The position search circuit 100 receives a substrate image, identifies an area representing a solder area, and generates a plurality of search images.

A search image may be generated in a rectangular shape, and in some embodiments the rectangular shape may be a square shape, and the search image may include position information represented by the coordinates of two vertices in a diagonal direction of the rectangle. That is, the position information may comprise coordinates such as cartesian coordinates of two opposite corners of the rectangle. The average or mean value of the coordinates of the two vertices represents the center point of the rectangle.

The position search circuit 100 may be implemented using a region detection neural network technology such as FASTER R-CNN. Since the FASTER R-CNN neural network is a well-known technology, a detailed description thereof is omitted from this disclosure.

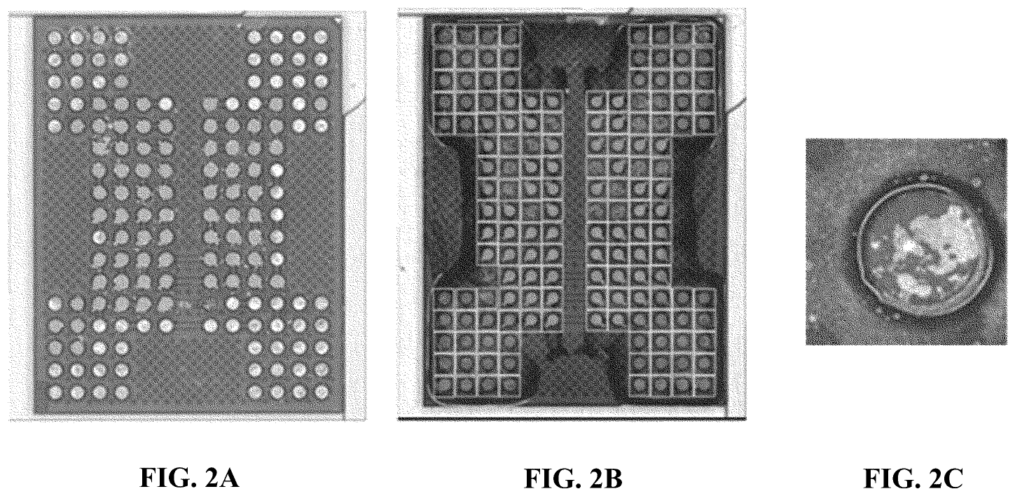

FIGS. 2A to 2C illustrate operations of the position search circuit 100.

FIG. 2A represents a substrate image, FIG. 2B represents a plurality of rectangular search images searched by the position search circuit 100, and FIG. 2C is an enlargement of one search image.

Returning to FIG. 1, errors may occur between a plurality of search images generated by the position search circuit 100 and actual solder areas included in the substrate.

Examples of errors may include a misalignment error in which a solder area is not completely included in a rectangular search image, an error in which a search image corresponding to a solder area is missing, etc.

Some of these errors can be managed through neural network learning, but errors cannot be eliminated unless a probability of missing some solder areas during the search is reduced to zero.

The inspection image generating circuit 200 generates a plurality of inspection images using a plurality of search images generated by the position search circuit 100 and a reference mask array.

The reference mask array includes a plurality of rectangular reference masks respectively corresponding to solder areas to be inspected on the substrate and their position information.

In this embodiment, the position information includes the coordinates of two vertices in a diagonal direction of the rectangle representing the reference mask. The average of the two vertex coordinates represents the center point of the reference mask.

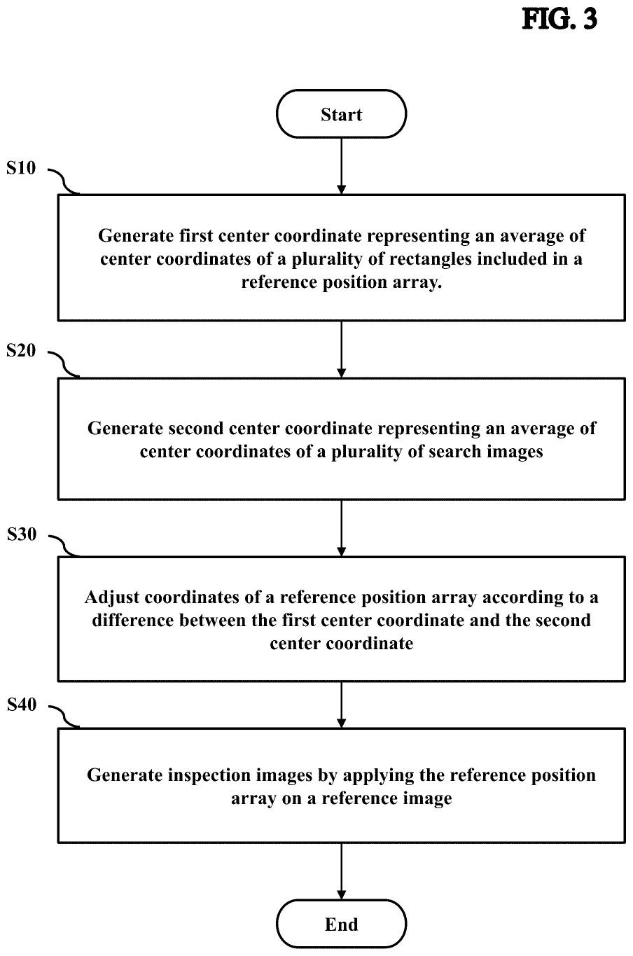

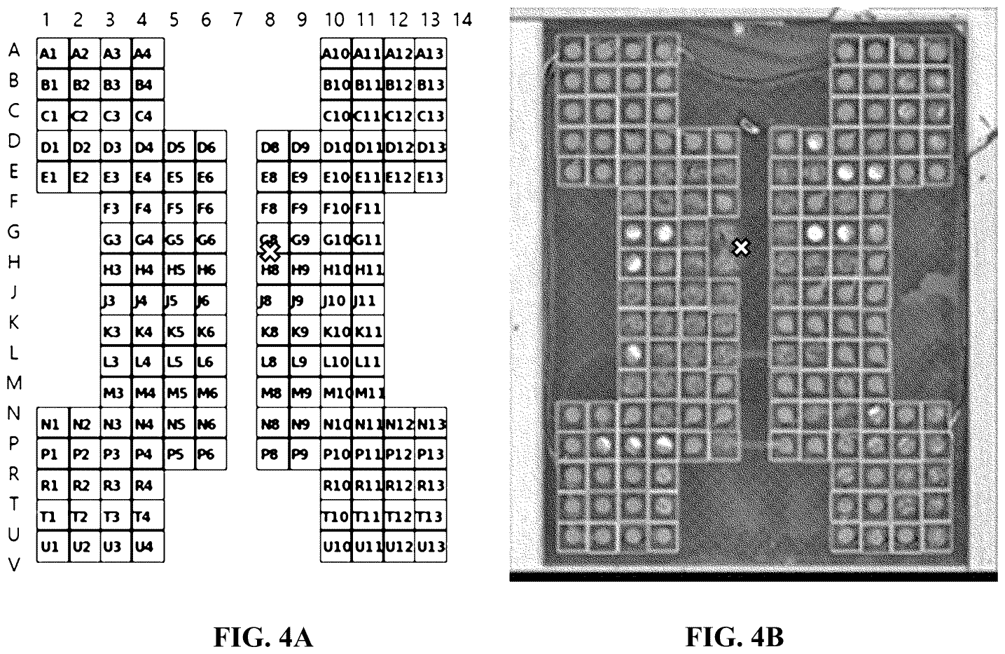

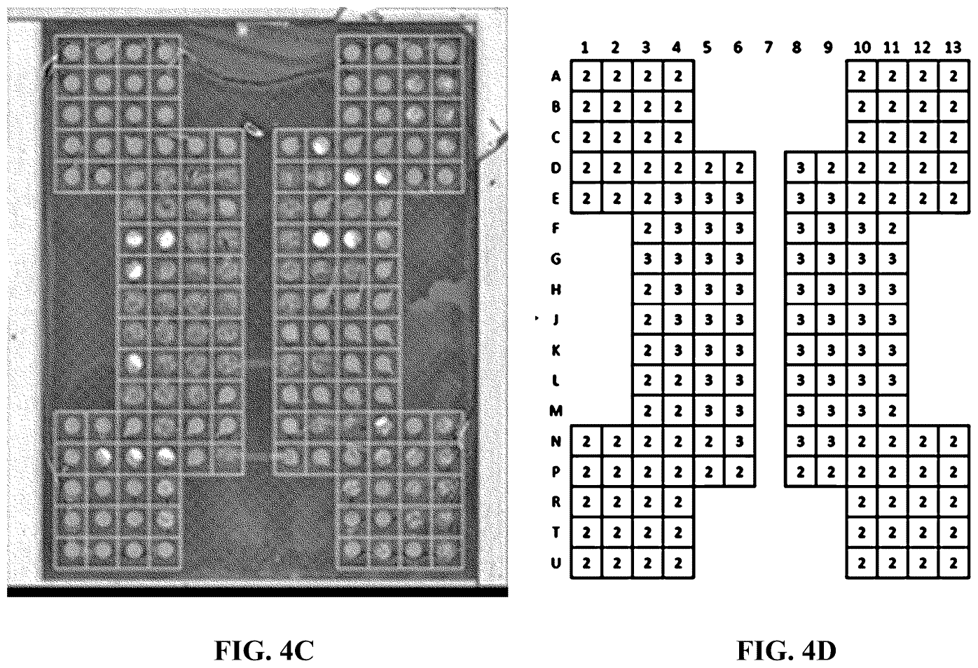

FIG. 3 is a flowchart showing an operation of the inspection image generating circuit 200, and FIGS. 4A to 4D illustrate operations of the inspection image generating circuit 200.

First, a first center coordinate representing an average of the center coordinates of a plurality of reference masks included in the reference mask array is obtained at S10. S10 may comprise determining center coordinates of a plurality of rectangular reference masks in an array of reference masks, and determining a center coordinate of the array based on an average of the center coordinates of the plurality of reference masks within the array.

FIG. 4A shows the positions of a plurality of reference masks included in the reference mask array and the first center coordinate. In FIG. 4A, the center coordinate of the plurality of reference masks is represented by an “X”.

Next, a second center coordinate representing the average of the center coordinates of a plurality of search images provided from the position search circuit 100 is obtained at S20. S20 may comprise determining center coordinates of a plurality of search images in a substrate image, and determining a second center coordinate of the array of search images based on an average of the center coordinates of the plurality of search images within the substrate image. In addition, a step of providing rectangular bounding boxes may be performed to generate the plurality of search images before determining their center coordinates. The bounding boxes may be applied by a CNN such as FASTER R-CNN, YOLO, or another CNN as known in the art.

FIG. 4B shows a rectangle representing the positions of a plurality of search images and the position of the second center coordinate, which is represented by an “X” in the figure.

Next, the position information included in the reference mask array is adjusted by the difference between the first center coordinate and the second center coordinate at S30. For example, coordinates of vertices of the reference masks in the array (or some other representative coordinate such as a center coordinate) may be adjusted by the difference between the first center coordinate and the second center coordinate, effectively offsetting the original coordinates of the reference masks to match coordinates of the search images.

Next, the reference mask array is applied to the substrate image to generate a plurality of inspection images at S40. The reference mask array may be applied to an original image of a substrate, e.g. an image of the substrate that is generated before the bounding boxes are applied as shown in FIG. 4B.

The position of the substrate image may vary depending on when the images were captured due, for example, to changes in alignment between the camera and a substrate that may occur between different images. Substrates are relatively small and optical magnification is typically used to capture images, and it is not practical to have identical alignment between the camera and the substrate for each image. Therefore, if the reference mask array is used without any adjustments to generate the inspection image, errors may occur in the inspection process.

In this embodiment, by adjusting the positions of a plurality of reference masks included in the reference mask array using the position information of a plurality of search images searched from the substrate image, and then extracting a plurality of inspection images from the substrate image using the plurality of reference masks, embodiments of the present disclosure may reduce the effect of variations in alignment between different inspection images. Therefore, it is possible to prevent solder areas from being missed during the inspection while reducing inspection errors.

FIG. 4C shows a plurality of rectangles representing a plurality of inspection images.

Returning to FIG. 1, the classification circuit 300 classifies each of the plurality of inspection images according to one or more state.

The states of the inspection images may include, for example, normal, solder ball crack occurrence, solder ball crack non-occurrence, PCB crack, PCB crack non-occurrence, package crack, package crack non-occurrence, etc. The package may refer to a semiconductor package, e.g. a material used to package a semiconductor substrate.

FIG. 4D shows numbers each corresponding to a state determined for each inspection image.

In this embodiment, the classification circuit 300 may be implemented using a deep neural network such as ResNet-18. Since ResNet-18 is a well-known neural network, a detailed description thereof is omitted. Hereinafter, the neural network used in the classification circuit 300 is referred to as a classification neural network.

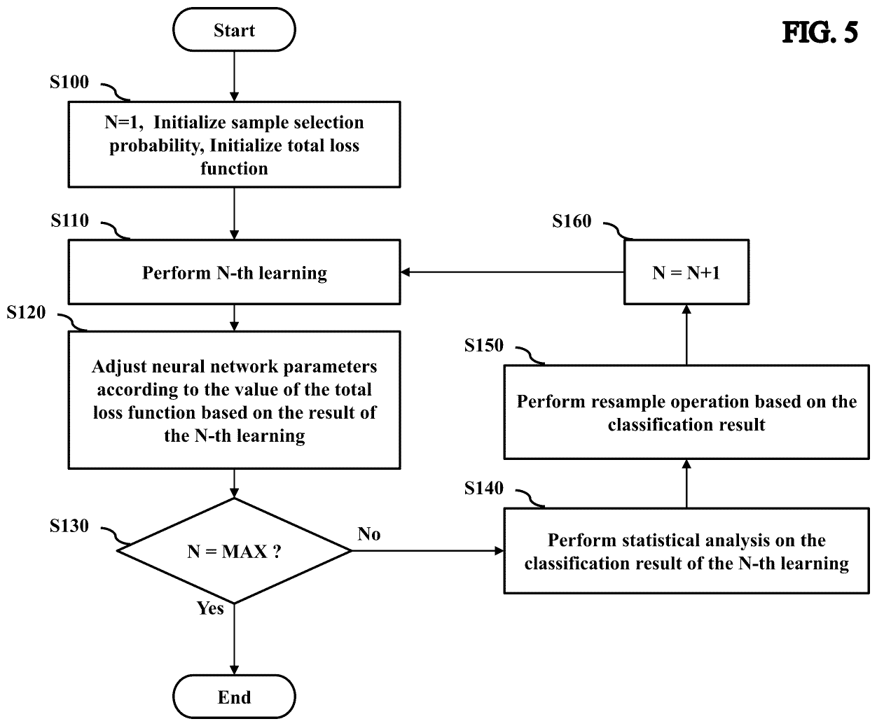

FIG. 5 is a flowchart showing a learning operation of the classification neural network according to an embodiment of the present disclosure. The learning operation may also be referred to as a training method for training a machine learning model which is implemented by the neural network. The steps of FIG. 5 may from start to end represent a learning epoch of the neural network.

First, a variable N is initialized to 1, and a sample selection probability and a total loss function are initialized.

In this embodiment, there are a plurality of states that are the targets of the classification, and accordingly, the probability of selecting a sample of each state from the learning data is initialized.

The initialization method may be implemented in various ways depending on the embodiment.

Assuming that there are a total of two states as the targets of the classification, the sample selection probability for each state may be initialized to 1/2. In another embodiment, the initial value of the sample selection probability for each state may be determined according to the ratio of the number of samples for each state.

For example, if the ratio of the number of samples corresponding to two states included in the population including the entire learning data is 1:2, the sample selection probability for each state can be initialized to 1/3 and 2/3.

The sample selection probability refers to the probability that a sample of a corresponding state is selected from the data set used during the learning operation. The data set used in the learning operation may be a subset of the population that includes the entire learning data.

In order to adjust the sample selection probability, the number of state-specific data included in the data set used in the learning operation may be adjusted.

Thereafter, an N-th learning is performed at S110.

Thereafter, the parameters of the classification neural network are adjusted according to the value of the total loss function calculated as a result of performing the N-th learning at S120.

Since the technology of adjusting the parameters of the neural network according to the result of calculating the loss function in the learning process of the deep neural network can be modified in various ways is known in the art, a detailed description is omitted.

Equation 1 represents a loss function corresponding to the n-th learning data included in the learning data set. Hereinafter, the n-th learning data can be referred to as the n-th sample.

The total loss function corresponding to all learning data corresponds to the sum of the loss function values of Equation 1 calculated for each sample included in the learning data set.

$${L}_{n} = - {α}^{( 1 - \frac{{s}_{t}}{{\sum }_{k = 0}^{C - 1} {s}_{k}} )} C ( {y}_{n}^{t} , {y}_{n} ) + ( 1 - δ ( {y}_{c}^{t} , {y}_{c}^{e} ) ) {α}^{( \frac{{s}_{e}}{{\sum }_{k = 0}^{C - 1} {s}_{k}} )} C ( {y}_{n}^{e} , {y}_{n} ) \qquad [ Equation 1 ]$$

In Equation 1, Sₖ represents the number of samples corresponding to the k-th state in the learning data set, Sₜ represents the number of samples corresponding to the true state of the n-th sample in the learning data set, and Sₑ represents the number of samples corresponding to the state estimated by the classification neural network for the n-th sample in the learning data set.

yₙ is a vector representing the probability of each state of the sample estimated by the classification neural network for the n-th sample. Hereinafter, this can be referred to as the neural network output vector.

yₙ^{t} has 1 only for the element corresponding to the true state of the n-th sample and 0 for the element corresponding to the remaining states. Hereinafter, this can be referred to as the true value vector.

yₙ^{e} is a vector representing the value estimated by the classification neural network for the n-th sample, and has 1 only for the element corresponding to the state with the highest probability among the predictions and 0 for the element corresponding to the remaining states. Hereinafter, this can be referred to as the estimation vector.

C(yₙ^{t},yₙ) represents the cross-entropy function between the output vector corresponding to the n-th sample and the true value vector.

C(yₙ^{e},yₙ) represents the cross-entropy function between the output vector and the estimation vector corresponding to the n-th sample.

δ(yₙ^{t}, yₙ^{e}) is the Kronecker delta function, which has a value of 1 if the true value vector and the estimation vector corresponding to the n-th sample are the same, and 0 otherwise.

Since the cross-entropy function and the Kronecker delta function themselves are well known, a detailed explanation is omitted.

α is a combination coefficient, and may be a constant greater than 1.

In Equation 1, the preceding term can be expressed as the T term, and the following term can be expressed as the F term. The T term corresponds to a case where the estimation result is true for the n-th sample, and the F term corresponds to a case where the estimation result is not true.

In the T term, the exponent of the combination coefficient has a larger value as the number of samples corresponding to the state of the n-th sample in the learning data set is smaller. Accordingly, the coefficient of the cross-entropy function in the T term also has a smaller value as the number of samples corresponding to the state of the n-th sample in the learning data set is smaller.

In the F term, the exponent of the combination coefficient has a smaller value as the number of samples corresponding to the state of the n-th sample in the learning data set increases. Accordingly, the coefficient of the cross-entropy function in the F term also has a smaller value as the number of samples corresponding to the state of the n-th sample in the learning data set increases.

As described above, in this embodiment, the coefficients corresponding to the T term and the F term change depending on the number of samples for each state due to the resampling operation.

That is, when the number of cases of incorrect estimation increases, the number of samples corresponding to incorrectly estimated states increases during (n+1)-th learning, so the influence of the coefficient of the F term in the total loss function increases, which can improve the learning efficiency as a result.

After that, it is determined whether N is the maximum value MAX at S130, and if N is the maximum value MAX, the learning operation is terminated.

If N is not the maximum value MAX, statistical analysis is performed on the classification results for each sample for all samples used in the N-th learning at S140.

For example, when a sample of the first state is input, the number of times the sample was classified as the first state, and the number of times the sample was classified as the second state can be written in a table format.

Thereafter, a resampling operation is performed by reflecting the statistical analysis results at S150.

The resampling operation is an operation that adjusts the sample selection probability to be used in (N+1)-th learning.

For example, the sample selection probability corresponding to the first state and the sample selection probability corresponding to the second state may be adjusted according to the ratio of cases where the first state was judged as the first state and cases where the first state was judged as the second state.

For example, the higher the ratio of incorrectly classifying the first state as the second state, the lower the sample selection probability corresponding to the first state and the higher the sample selection probability corresponding to the second state.

Through these the learning processes, operation corresponding to the second state can be improved, thereby improving the inference performance.

The technique for adjusting the sample selection probability in the resampling operation can be changed in various ways depending on the embodiment.

The result of performing the resampling operation is reflected in the (N+1)-th learning.

As a result of performing the resampling operation, the number of samples for each state in the (N+1)-th learning data set is adjusted.

Accordingly, the value of the exponent of the coefficient in Equation 1 is changed, which has the effect of simultaneously changing the weight of the loss function. Through this, the learning performance can be further improved.

After that, N is increased by 1 at S160 and (N+1)-th learning is performed at S110. Since the subsequent operations are repetitions of the aforementioned operations, descriptions thereof are not repeated here.

Embodiments of the present disclosure include a method of inspecting solder areas of a substrate. A method of inspecting solder areas of a substrate may comprise receiving an inspection image of a solder area and determining a state of the solder area in the image. The state may be a quality state such as a state of the integrity of one or more of the solder material or a package or PCB associated with the solder material. The method may comprise loading a substrate into a solder inspection device, capturing an image of solder areas of the substrate using an image capturing device (e.g. a camera), and classifying inspection images of solder areas as having a state representing a quality characteristic of the solder area, such as whether a crack is present in a solder material or an area of the substrate adjacent to the solder material. The method of inspecting solder areas may comprise processing inspection images of the solder areas using a machine learning model which is trained using the processes discussed above with respect to FIG. 5.

Although various embodiments have been described for illustrative purposes, it will be apparent to those skilled in the art that various changes and modifications may be made to the described embodiments without departing from the spirit and scope of the disclosure as defined by the following claims.

What is claimed is:

1. A solder inspection device comprising:
a position search circuit configured to receive a substrate image of a substrate including a plurality of solder areas and to generate a plurality of search images respectively corresponding to the plurality of solder areas;
an inspection image generating circuit configured to generate a plurality of inspection images respectively corresponding to the plurality of solder areas using a plurality of reference masks and position information of the plurality of search images; and
a classification circuit configured to classify each of the plurality of inspection images as having one of a plurality of states.

2. The solder inspection device of claim 1, wherein the inspection image generating circuit is further configured to adjust positions of the plurality of reference masks based on position information of the plurality of search images, and to extract the plurality of inspection images from the substrate image using the plurality of reference masks.

3. The solder inspection device of claim 2, wherein the inspection image generating circuit is further configured to adjust the positions of the plurality of reference masks using a first coordinate representing an average of center coordinates of the plurality of reference masks and a second coordinate representing an average of center coordinates of the plurality of search images.

4. The solder inspection device of claim 1, wherein the classification circuit is further configured to perform a neural network operation on each of the plurality inspection images and determines each of the plurality of inspection images as having one of a plurality of states based on result of the neural network operation.

5. A method of operating a solder inspection device, the method comprising:
receiving, by a classification neural network of the solder inspection device, a plurality of inspection images of solder areas of a substrate;
assigning one of a first state and a second state to the inspection image;
determining, in a first epoch learning of the classification neural network, a number of first cases for which a sample of the first inspection image having the first state is classified as having the first state, and a number of second cases for which the sample of the first inspection image having the first state is classified as having the second state; and
adjusting a first selection probability that a sample of the first state is selected and a second selection probability that a sample of the second state is selected during the next epoch learning.

6. The method of claim 5, wherein adjusting the first selection probability and the second selection probability comprises:
decreasing the first selection probability and increasing the second selection probability when the number of first cases is smaller than the number of second cases.

7. The method of claim 5, wherein a value of a loss function when a sample is applied to the classification neural network includes a first term corresponding to the first case and a second term corresponding to the second case, the method further comprising:
determining the first term by multiplying a first loss parameter and a first cross-entropy function; and
determining the second term by multiplying a second loss parameter and a second cross-entropy function.

8. The method of claim 7, further comprising:
adjusting the first loss parameter and the second loss parameter by the first selection probability and the second selection probability during the next epoch learning.

9. The method of claim 5, wherein the first state is one of a solder crack occurrence, a printed circuit board (PCB) crack occurrence, and a package crack occurrence, and the second state is one of a solder crack non-occurrence, a PCB crack non-occurrence, and a package crack non-occurrence.
